(19) United States
(12) Patent Application Publication
(10) Pub. No.: US 2011/0113776 A1
(43) Pub. Date: May 19, 2011

(54) Aero-Hydro Power Plant

(76) Inventor: Purna Bahadur Kharkathoki, West Bengal (IN)

(21) Appl. No.: 13/054,332

(22) PCT Filed: Jul. 8, 2009
(86) PCT No.: PCT/IN09/00383

§ 371 Date: Jan. 20, 2011

(30) Foreign Application Priority Data
Jul. 18, 2008 (IN) 1229/KOL/2008

(51) Int. Cl. F03B 7/00; F03B 13/00

(52) U.S. Cl. 60/639; 415/121.3

(57) ABSTRACT

Aero-Hydro power plant consists of a set of fixed moving discs. The incoming air enters the fixed disc (01) in a straight direction and then turns into 85 degrees by the specially designed fixed disc (01). The wind is thus further directed to the rotating disc (02) at high velocity and then leaves out of the rotating disc (02) in about 80-85 degrees giving maximum thrust. After that the rotating motion is transferred into the gear box (05) with the help of 2 nos. ball bearing (03). A gearbox (05) is provided to increase the R.P.M. A brake (06) is provided in between the coupling (07) and gearbox (05) so as to control the R.P.M. extracted from the gearbox (05). Further the coupling (07) is connected to dynamo/alternator (03) which produces electricity. When the air flows normally the water pump is used to fill the funnel shaped water tank reservoir (09), and later on released downwards with maximum force.

### BACKGROUND OF THE INVENTION

Wind energy is non-exhaustible source of energy. Moreover, it is source of energy, which is available in every part of the world. The main objective of this invention is to utilize the wind energy. So now I am going to discuss about the wind turbines that are in operation at present.

Types of Wind Turbines

Horizontal-Axis

Horizontal-Axis Wind Turbines (HAWT)

Most wind machines being used today are the horizontal axis type. Horizontal-axis wind machines have blades like airplane propellers. A typical horizontal wind machines stands as tall as a 20 story building and has here blades that span 200 feet across. The largest wind machines in the world have blades longer than a football field. Wind machines stand tall and wide o capture more wind. See FIG. 1.

HAWT Advantages
Blades are to the side of the turbine's center of gravity helping stability.
Variable blade pitch, which gives the turbine blades the optimum angle of attack. Allowing the angle of attack to be remotely adjusted gives greater control, so the turbine collects the maximum amount of wind energy for the time of day and season.
Ability to feather the rotor blades in a storm, to minimize damage.
Tall tower allows access to stronger wind in sites with wind shear. In some wind shear sites, every ten meters up, the wind speed can increase by 20% and the power output by 34%

HAWT Disadvantages
HAWTs have difficulty operating in near ground, turbulent winds.
The tall towers and long blades up to 90 meters long are difficult to transport on sea and on land. Transportation can now cost 20% of equipment costs.
All HAWTs are difficult to install, needing very tall and expensive cranes and skilled operators.
The FAA has raised concerns about tall HAWTs effects on radar near Air Forces bases.
Their height can create local opposition based on impacts to view sheds.
Downwind variants suffer from fatigue and structural failure caused by turbulence.

Vertical-Axis.

Vertical-Axis Wind Turbines (VAWT)

Vertical-axis wind machines have blades that go from top to bottom and the most common type (Darrieus wind turbine) looks like a giant two-bladed eggbeaters. The type of vertical wind machine typically stands 100 feet tall and 50 fee wide. Vertical-axis wind machines make up only a very small percent of the wind machines used today. See FIG. 2. The Wind Amplified Rotor Platform (WARP) is a different kind of wind system that is designed to be more efficient and use less land than wind machines in use today. The WARP does not use large blades; instead, it looks like a stack of wheel rims. Each module has a pair of small, high capacity turbines mounted to both of its concave wind amplifier module channel surfaces. Te concave surfaces channel wind toward the turbines, amplifying wind speeds by 50 percent or more. Eneco, the company that designed WARP, plans to market the technology o power offshore oil platforms and wireless telecommunications systems.

VAWT Advantages.
Can be easier to maintain if the moving parts are located near the ground.
As the rotor blades are vertical, a yaw device is not needed, reducing cost.
VAWTs have a higher airfoil pitch angle, giving improved aerodynamics while decreasing drag at low and high pressures.
Straight bladed VAWT designs with a square or rectangular cross-section have a larger swept area for a given diameter than the circular swept area of HAWTs.
Mesas, hilltops, ridgelines and passes can have faster winds near the ground because the wind is forced up a slope or funneled into a pass and into the path of VAWTs situated close to the ground.
Low eight useful where laws do not permit structures to be placed high.
Does not need a freestanding tower so is much less expensive and stronger in high winds that are close to the ground.
Usually have a lower tip-speed ratio so less likely to break in high winds.
Does no need to turn to face the wind if the wind direction changes making them ideal in turbulent wind conditions.
They can potentially be built to a far larger size than HAWT's for instance floating VAWT's hundreds of meters in diameter where the entire vessel rotates, can eliminate the need for a large and expensive bearing.
There may be a height lamination to how tall a vertical wind turbine can be built and how much sweep area it can have. However, his can be overcome by connecting a multiple number of turbines together in a triangular pattern with bracing across the top of the structure. Thus reducing the need for such strong vertical support, and allowing the turbine blades to be made much longer.

VAWT Disadvantages.
Most VAWTs produce energy at only 50% of the efficiency of HAWTs in large part because of the additional drag that they have as their blades rotate into the wind. This can be overcome by using structures to funnel more and align the wind into the rotor (e.g. “Stators” on early Windstar turbines) or he “Vorex” effect of placing straight bladed VAWTs closely together (e.g. U.S. Pat. No. 6,784,566).
Most VAWTs need to be installed on a relatively flat piece of land and some sites could be too steep for them but are sill useable by HAWTs.)
Most VAWTs have low starting torque, and may require energy to start turning.
A VAWT that uses guy wires to hold it in place puts stress on the bottom bearing as all the weight of the rotor is on the bearing. Guy wires attached to the top bearing increase downward thrust in wind gusts. Solving this problem requires a superstructure to hold a top bearing in place o eliminate the downward thrusts of gust events in guy wired models.
While VAWTs parts are located on the ground, they are also located under the weight of the structure above it, which can make changing our parts near impossible without dismantling the structure if not designed properly.

This project namely Bhuma Aero-Hydro power plant is capable of overcoming most of the disadvantages of the above said two types of wind turbines. This invention can solve most of the above-mentioned problems by applying the following methods:

1. This invention uses two types of discs, one is fixed blade assembly and the other is the rotating part. The blades are made angular so as to take most of the energy from incident wind. The gaps are made small to minimize the energy losses. This allows the blades to catch the maximum energy from the wind.
2. This invention uses a new type of device named funnel shaped water storing tank reservoir. The exist water gains speed and pressure which strikes the rotor blade tangentially at the circumference of the rotor. The effect of the pressure may work in between the angle of 0 to 50 degrees up and downward measured from the entire and through diameter of the rotating disc.

The power of the downward falling water increases the speed of the rotating disc. A/C or D/C current supplies may be used in this invention. The current supplies should be self rechargeable which can take small quantity of current from the production and give the continuous motion to the rotating disc which is helpful to produce more current by using the natural renewable source—The Wind Power and the help of water resource.

### SUMMARY OF THE INVENTION

Let us assume that the wind blows at a minimum speed of 2 msec. or more. The wind flowing is incident directly on the guide vanes or the fixed disc. The wind incident on the guide vanes is then deflected by it in a convenient direction to make it incident on the rotor blade assembly. The guide vanes turn the wind by an angle of 85°. The wind is incident on the rotating disc or the rotor; this wind forces the rotor to rotate. The angle between the incident wind and the wind leaving at the rotor blade is nearly 80-85°. The angle is such that it gives the maximum possible thrust to the rotor.

Now to overcome the problems of wind flowing at relatively lower speed, a new technique is being used here. A funnel stored with water has been introduced. The water is being stored in the funnel tank reservoir. The water from the tank falls from tank and reaches the upper cross sectional area of he funnel to the lower cross sectional area of the funnel. The lower cross sectional area of the funnel is much smaller in size than the upper one, so the velocity and pressure of the water coming out is much higher than that at the upper part.

The water from the funnel is incident directly on the rotating disc's outer edge at nearly 90 degrees so as to increase the speed of rotation of the rotor. The effect of the water pressure, which hits the rotor blades works in between the angle of 0 to 50 degree upward or downward, measured from the center along the diameter of the rotating disc. This method allows the rotor to produce an extra amount of energy.

The rotor is fixed to a high speed shaft, which is being connected to the armature of the dynamo by a coupling. When the rotor starts rotating, it rotates he armature of the dynamo as well. This dynamo converts the mechanical energy of the shaft to electrical energy. By this technique, some part of the power is utilized to store water in the tank and the major part of the extracted power is supplied as electrical energy. This technique can utilize 90% to 95% of the energy flowing in the wind and also when the air is not flowing, the water stored in the tank will help to run the windmill. This technique can be utilized to extract power for continuously 24 hours. Whether the wind blows or not, it does not effect the rotation of the rotor disc and hence it helps to produce more and more electricity.

### BRIEF DESCRIPTION OF THE ACCOMPANYING DRAWINGS

FIG. 1 illustrates the prior art Horizontal-axis wind turbines (HAWT) as available.

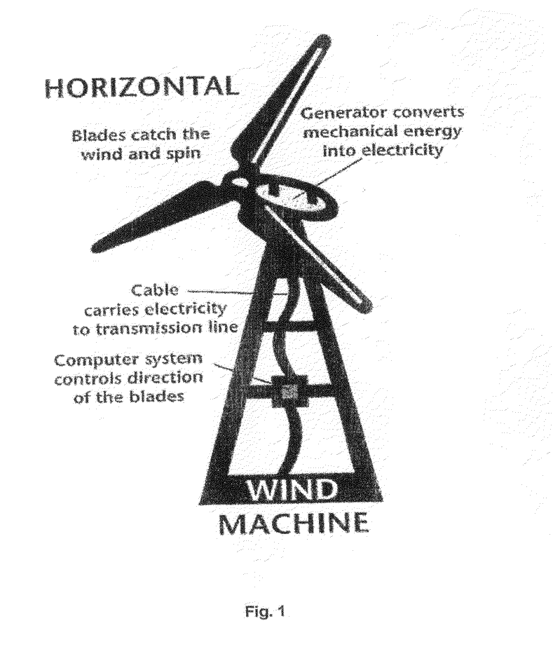

FIG. 2 illustrates the prior art Vertical axis wind turbine (VAWT) as available.

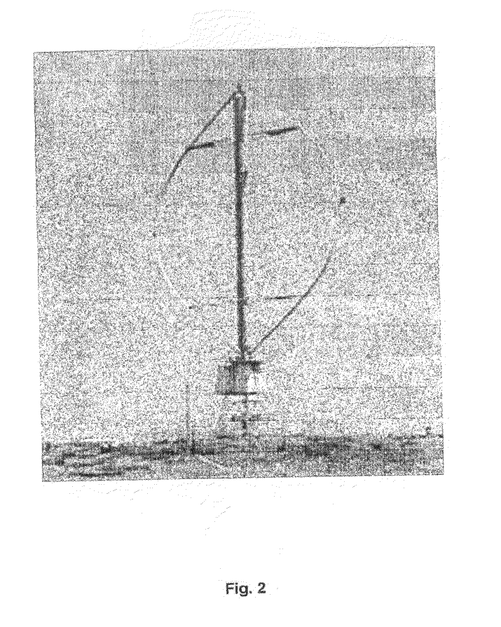

FIG. 3 illustrates the block diagram of Aero-Hydro Power Plant according to the present invention.

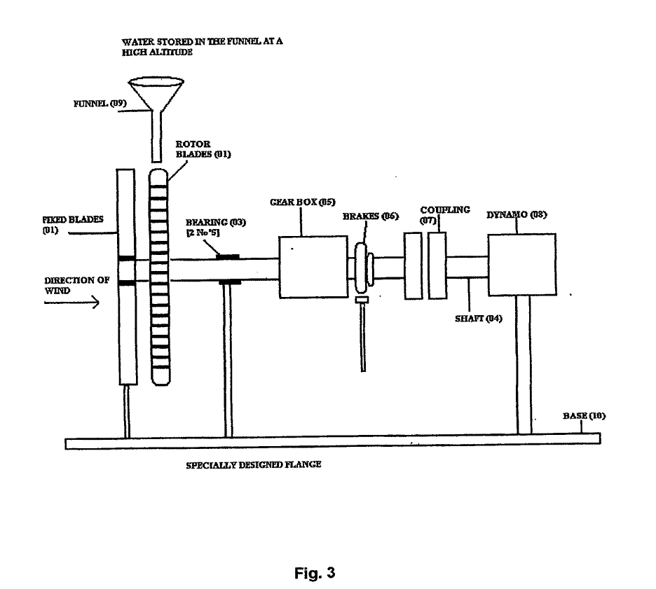

FIG. 4 illustrates angle of pressure at Aero-Hydro Power Plant according to the present invention.

FIG. 5 illustrates schematic view of Funnel (Water storing tank) and Set of rotating disc according to the present invention.

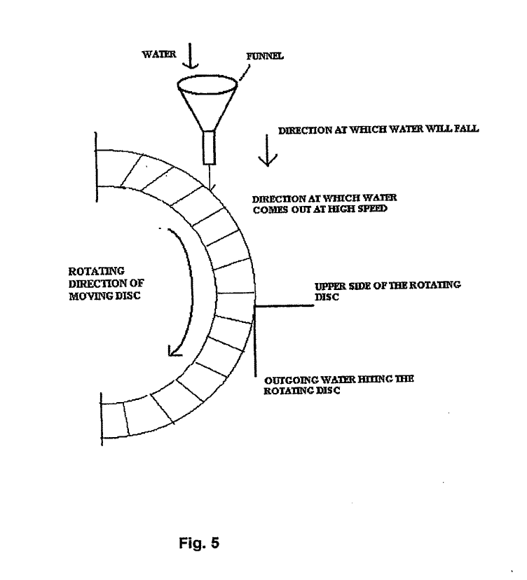

FIG. 6 illustrates the Front View of Aero-Hydro Power Plant according to the present invention.

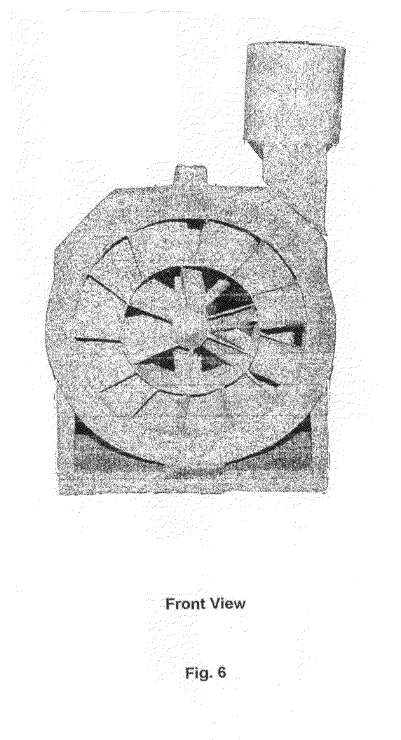

FIG. 7 illustrates the Rear view of Aero-Hydro Power Plant according to the present invention.

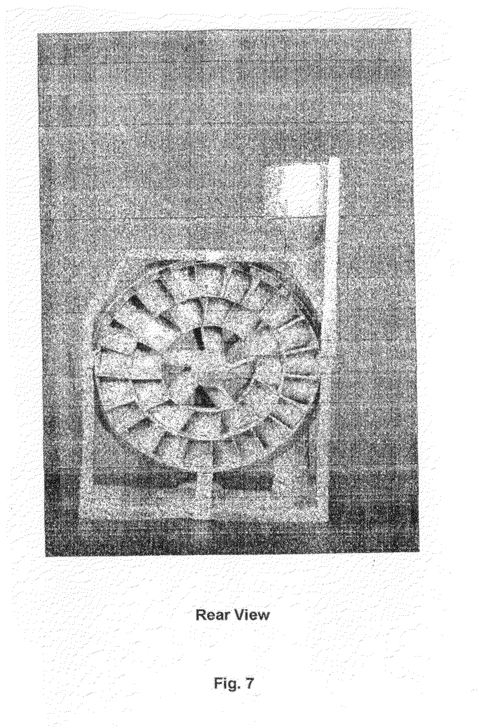

FIG. 8 illustrates the Right side view of Aero-Hydro Power Plant according to the present invention.

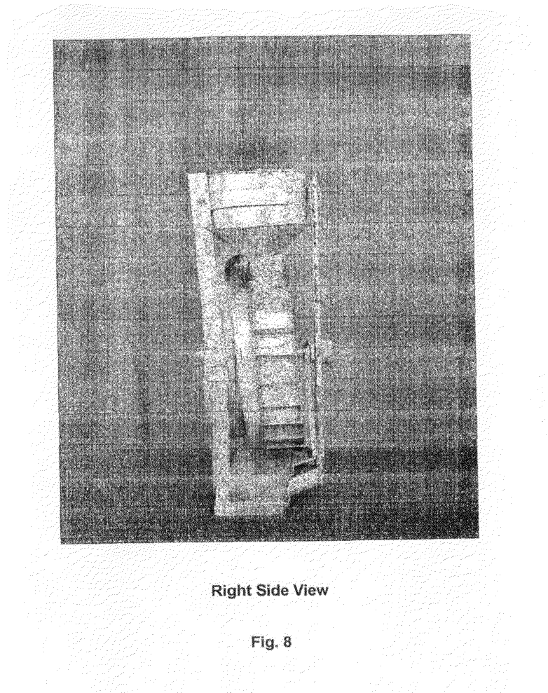

FIG. 9 illustrates the Left side view of Aero-Hydro Power Plant according to the present invention.

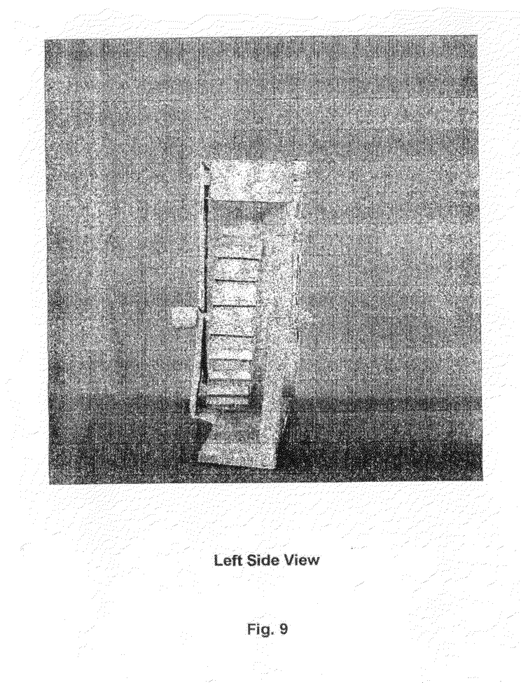

### PARTS OF BHUMA AERO-HYDRO POWER PLANT

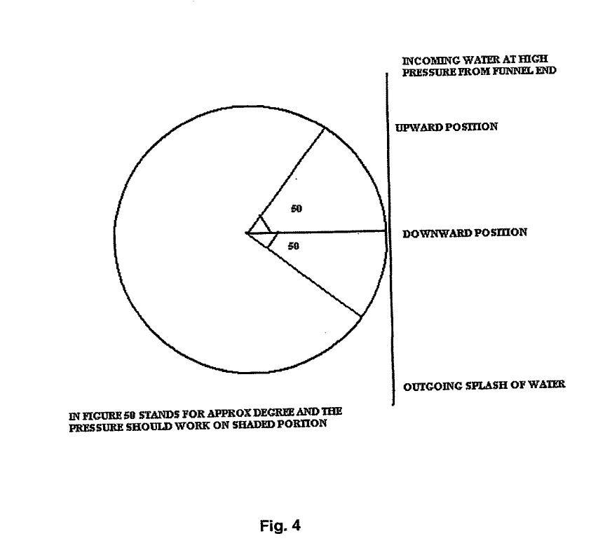

1. Set of fixed disc.
2. Set of rotating disc.
3. Ball bearing.
4. Shaft
5. Gears
6. Brakes
7. Coupling
8. Dynamo
9. Funnel (Water storing tank)
10. Base of the whole structure
11. Structure of the blades of rotating disc.
12. Stand to hold the water reservoir tank funnel (FIG. 4)

### DESCRIPTION AND WORKING OF THE VARIOUS PARTS

### 1. Set of Fixed Disc

The full assembly is divided into required number of concentric set of fixed blades. The number and size of the concentric set of fixed disc are different. The concentric sets of fixed blades are designed to get equal torque on concentric parts for a particular design velocity.

Set of Rotating Disc:

Though the diameter and the division of the set of rotating blades is similar to that of the assembly of fixed blades but unlike fixed disc they are designed for maximum momentum change. This assemble of rotating blades is placed behind the fixed disc system and is directly connected to he shaft which in turn is attached to he dynamo via a coupling through a gearbox. This system of rotating disc utilizes the wind converged by the fixed blades.

Ball Bearing

It is used to support the moving shaft on the fixed disc frame. This technology is generally used to reduce friction. Due to the presence of dust and moisture in the air, the ball bearing, on which all the parts rotates (except front blades) smoothly should be covered by the double “Z” and the rubber seal protection.

Shaft

The basic function of the shaft is to feed the dynamo with the angular velocity attained by the rotating blades. The various parts of the generator are connected along the length of the shaft with or without the use of ball bearing.

Gears

Gears are provided to convert the high torque of the rotor blades to the necessary RPM. It is placed between the shaft and the coupling. The gears that should be provided here is of the sep-up-type.

Brakes

Brakes are provided on the low speed shaft to govern the speed of the shaft. Brakes helps control the output RPM of the shaft.

Coupling

The coupling connects the shaft with the dynamo.

Dynamo

This part of the generator is used to convert he mechanical energy (angular velocity) attained by the rotating blades into electrical energy.

Funnel

In this assembly the funnel storage tank is se on the two pillars and later on the numbers or shape of the pillars may be increased or modified, depending on the weight of the tank (Sheet NO. 3). The water from the funnel is incident directly on the rotating disc outer at nearly 90 degree and hits the rotor disc in between angle 0-50 degree upward or downward which gives extra torque to the rotor disc.

Base if the Whole Structure

Base of the whole structure is made quite strong so that the not only it can withstand the dead weight of he generator but also can take care of the

Structure of the Blades of the Rotating Blades

Rotating blades utilize maximum energy of the incident air from the fixed blades. The incident air experiences a momentum change, which exerts a pressure on the blades, which results in he circular motion of the blades. There are two types of blades used. One type of blades are placed radically from the center which utilizes most of the energy of the wind incident from the fixed disc. The blades are nearly semi cylinder in shape. The following picture explains it all.

The other type of blades is placed on the circumference. The water stored in the funnel which brings about the circular motion of the disc at high speed. This process can improve the speed of the rotating disc.

What is claimed is:

1. Aero-Hydro Power Plant is improved windmill equipment comprising of: a windmill starting promotional equipment mainly consisting of (a) set of fixed blades (b) set of rotating disc (c) Ball bearing (d) Shaft (e) Gear Box containing gear drive (f) Brakes (g) Coupling (h) Dynamo (i) Funnel for storage of water (j) Base frame.

2. Aero-Hydro Power Plant as claimed in claim 1, is detailed as: —(10) a base frame that will support the whole equipment i.e. the set of fixed and the rotating turbine and all gadgets mentioned in the sheet No. 01.

3. Aero-Hydro Power Plant as claimed in claim 1, wherein the incoming air through the fixed blades will enter the concentric set of fixed disc to get equal torque on concentric parts and the specialized design of the rotating blades to get maximum momentum of air.

4. Aero-Hydro Power Plant as claimed in claim 1, wherein the funnel shaped tank reservoir is places over the top of moving disc assembly which is supported over two pillars through which the stored water will fall on the specially designed flange shown in sheet No. 03.

5. Aero-Hydro Power Plant as claimed in claim 1, in which the water at high pressure will fall upward position at 90 degree and the water will splash out in the downward position between 0-50 degrees as shown in sheet No. 06.

6. Aero-Hydro Power Plant as claimed in claim 1, wherein the promotional equipment consists of same number of blades as of windmill and equal to or more than the circumferential size of the windmill blades.

7. Aero-Hydro Power Plant as claimed in claim 1, wherein the promotional equipment and the windmill blades are kept minimum preferably around 0.5 mm as to transfer maximum amount of wind energy to blades.

8. Aero-Hydro Power Plant as claimed in claim 1, further consists of a set of ball bearings that will transfer the motion of the rotting blades to the gear box fitted just after the set of blades in the line assembly method. (Gear box is used to increase the R.P.M. obtained from the moving blades).

9. Aero-Hydro Power Plant as claimed in claim 1, further consists of brakes fitted just after the gear box to control to R.P.M. obtained from the gear box to the Dynamo via set of couplings.

10. Aero-Hydro Power Plant as claimed in claim 1, will expertise in running the traditional wind mill even when the air is not blowing by the help of water stored at a high altitude pumped by a water pump during the time of sufficient flow of natural air.

11. Aero-Hydro Power Plant as claimed in claim 1, we fervently sate that in FIG. 4, the shaded portion in the outskirt of the rotating disc of all types cannot be copied or renovated as per our claim for patent.

12. Aero-Hydro Power Plant as claimed in claim 1, can be further described as an energy saving equipment as even when the water is pumped at a high altitude, it doesn't require electric as the water can be pumped with the help of extra gears fitted with the gear box. (Not mentioned in any diagram, but can be stated later on during examination).
